(19) United States
(12) Patent Application Publication
(10) Pub. No.: US 2024/0428154 A1
(43) Pub. Date: Dec. 26, 2024

(54) TECHNOLOGIES FOR CLOUD-BASED ANALYSIS AND OPTIMIZATION OF IN-PERSON ATTENDANT INTERACTIONS

(71) Applicant: Genesys Cloud Services, Inc., Menlo Park, CA (US)

(72) Inventors: Cliff Bell, Menlo Park, CA (US); Dan Stoops, Menlo Park, CA (US)

(21) Appl. No.: 18/340,677

(22) Filed: Jun. 23, 2023

(51) Int. Cl. G06Q 10/0631

(52) U.S. Cl. CPC G06Q 10/063116

(57) ABSTRACT

A method for analysis of in-person attendant interactions according to an embodiment includes determining a location of a person within a monitored area based on sensor data generated by one or more sensors, determining a start queue time associated with a time at which the person is located at a start queue position within the monitored area, determining an end queue time associated with a time at which the person is located at an end queue position, recording interaction data of an interaction between the person and an attendant when the person is located at the end queue position, determining a wait time of the person in the queue based on the start queue time and the end queue time, determining an interaction time of the interaction based on the interaction data, and adjusting an attendant schedule for the monitored area to improve the wait time or the interaction time.

### BACKGROUND

Branch and in-person service centers, such as airport VIP lounges, often face scheduling, quality, and performance management challenges, yet they do not have the appropriate technology to ensure staff engagement is fine-tuned. As such, when staffing in-person service centers, organizations typically rely on historical staffing patterns and duplicate prior staffing decisions. For example, an organization that assigns four staff members to afternoons on Mondays of one year may also assign four staff members to afternoons on Mondays of the subsequent year.

### SUMMARY

One embodiment is directed to a unique system, components, and methods for analysis of in-person attendant interactions. Other embodiments are directed to apparatuses, systems, devices, hardware, methods, and combinations thereof for analysis of in-person attendant interactions.

According to an embodiment, a method for analysis of in-person attendant interactions may include determining a physical location of a person within a monitored area based on sensor data generated by one or more sensors, determining a start queue time associated with a time at which the person is located at a start queue position of a queue within the monitored area in response to determining that the person is located at the start queue position, determining an end queue time associated with a time at which the person is located at an end queue position of the queue within the monitored area in response to determining that the person is located at the end queue position, recording interaction data of an interaction between the person and an attendant when the person is located at the end queue position, determining a wait time of the person in the queue based on the start queue time and the end queue time, determining an interaction time of the interaction between the person and the attendant based on the interaction data, and adjusting an attendant schedule of one or more attendants of the monitored area to improve one or more of the wait time and the interaction time.

In some embodiments, the one or more sensors may include a plurality of pressure sensors.

In some embodiments, the one or more sensors may include a first sensor and a second sensor, determining the start queue time may include determining the start queue time in response to determining that sensor data generated by the first sensor is indicative of the person being located at the start queue position, and determining the end queue time may include determining the end queue time in response to determining that sensor data generated by the second sensor is indicative of the person being located at the end queue position.

In some embodiments, the first sensor may be or include a first pressure sensor, and the second sensor may be or include a second pressure sensor.

In some embodiments, the one or more sensors may include a camera.

In some embodiments, the method may further include determining a physical location of the attendant based on the sensor data generated by the one or more sensors, and recording the interaction data of the interaction between the person and the attendant may include recording the interaction data when the person is located at the end queue position and the attendant is located at a queue handling position.

In some embodiments, the method may further include analyzing a plurality of wait times including the wait time of the person in the queue based on an optimal wait time, and analyzing a plurality of interaction times including the interaction time of the interaction between the person and the attendant based on an optimal interaction time.

In some embodiments, the method may further include analyzing, using speech recognition, content of the interaction between the person and the attendant based on the interaction data to determine content compliance of the attendant.

In some embodiments, the method may further include transmitting the sensor data to a cloud-based computing system via an Application Programming Interface (API), determining the wait time of the person may include determining the wait time of the person by the cloud-based computing system, and determining the interaction time of the interaction may include determining the interaction time of the interaction by the cloud-based computing system.

In some embodiments, the method may further include analyzing the wait time of the person in the queue and the interaction time of the interaction based on a machine learning model of a contact center system.

According to another embodiment, a system for analysis of in-person attendant interactions may include one or more sensors configured to generate sensor data, at least one processor, and at least one memory comprising a plurality of instructions stored thereon that, in response to execution by the at least one processor, causes the system to determine a physical location of a person within a monitored area based on the sensor data generated by the one or more sensors, determine a start queue time associated with a time at which the person is located at a start queue position of a queue within the monitored area in response to a determination that the person is located at the start queue position, determine an end queue time associated with a time at which the person is located at an end queue position of the queue within the monitored area in response to a determination that the person is located at the end queue position, record interaction data of an interaction between the person and an attendant when the person is located at the end queue position, determine a wait time of the person in the queue based on the start queue time and the end queue time, determine an interaction time of the interaction between the person and the attendant based on the interaction data, and adjust an attendant schedule of one or more attendants of the monitored area to improve one or more of the wait time and the interaction time.

In some embodiments, to adjust the attendant schedule of the one or more attendants of the monitored area may include to increase a number of attendants scheduled for a predefined shift.

In some embodiments, the one or more sensors may include a plurality of pressure sensors.

In some embodiments, the one or more sensors may include a first sensor and a second sensor, to determine the start queue time may include to determine the start queue time in response to a determination that sensor data generated by the first sensor is indicative of the person being located at the start queue position, and to determine the end queue time may include to determine the end queue time in response to a determination that sensor data generated by the second sensor is indicative of the person being located at the end queue position.

In some embodiments, the first sensor may be or include a first pressure sensor, and the second sensor may be or include a second pressure sensor.

In some embodiments, the one or more sensors may include a camera.

In some embodiments, the plurality of instructions may further cause the system to determine a physical location of the attendant based on the sensor data generated by the one or more sensors, and to record the interaction data of the interaction between the person and the attendant may include to record the interaction data when the person is located at the end queue position and the attendant is located at a queue handling position.

In some embodiments, the plurality of instructions may further cause the system to analyze a plurality of wait times including the wait time of the person in the queue based on an optimal wait time, and analyze a plurality of interaction times including the interaction time of the interaction between the person and the attendant based on an optimal interaction time.

In some embodiments, the plurality of instructions may further cause the system to analyze, using speech recognition, content of the interaction between the person and the attendant based on the interaction data to determine content compliance of the attendant.

In some embodiments, the plurality of instructions may further cause the system to transmit the sensor data to a cloud-based computing system via an Application Programming Interface (API), to determine the wait time of the person may include to determine the wait time of the person by the cloud-based computing system, and to determine the interaction time of the interaction may include to determine the interaction time of the interaction by the cloud-based computing system.

In some embodiments, the plurality of instructions may further cause the system to analyze the wait time of the person in the queue and the interaction time of the interaction based on a machine learning model of a contact center system.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a system for cloud-based analysis and optimization of in-person attendant interactions;

FIG. 2 is a simplified block diagram of at least one embodiment of a computing device;

FIG. 3 illustrates a simplified exemplary floor plan of a monitored area;

FIG. 4 is a simplified flow diagram of at least one embodiment of a method of recording data for the cloud-based analysis and optimization of in-person attendant interactions; and

FIG. 5 is a simplified flow diagram of at least one embodiment of a method of analyzing and optimizing in-person attendant interactions.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

In-person service centers, such as airport VIP lounges, face many of the same scheduling, quality, and performance management challenges faced by contact centers, but they lack the technology to fine-tune staffing engagement in a manner that one would do with virtual resources, such as in a contact center. Additionally, the scheduling, quality, and performance are managed independently from the customer experience evaluation. For example, a client experience at an airport VIP lounge may have separate sequences for the client and the lounge staff member. An example client experience may include waiting in line to check into the lounge, visiting with the front desk to check in with a staff member, checking into the lounge, asking a question of a staff member (e.g., whether any flights are leaving earlier and whether there are any available seats on those flights), and walking over to the snack area to grab a treat. Separately, an example staff experience may include being scheduled to work on Tuesday, arriving at the lounge on time to begin the shift, checking a client into the lounge, answering some questions asked by the client, leaving the front desk for several minutes, and wondering what remains of the snack inventory. Although these experiences have some overlap in the physical world, current technologies treat the evaluations of the experiences separately. There is no (or limited) awareness into how long the client waited in line, what questions were asked prior to checking in (or after checking in), how the staff member responded, how long the check-in process took, how long the interaction between the staff member and client took in total, how the overall client experience related to the length of time waiting in line or talking to a staff member, and/or other facets of the interactions.

It should be appreciated that the technologies described herein allow for connecting technology to gather inputs from in-person service centers, automatically analyzing and identifying optimal wait and interaction times for in-person interactions, and applying alerting, quality, and performance management techniques based on such data. For example, in an illustrative embodiment, the in-person environment data may be transmitted to a remote system and analyzed using a contact center system infrastructure, machine learning model of a contact center, and/or using similar technologies.

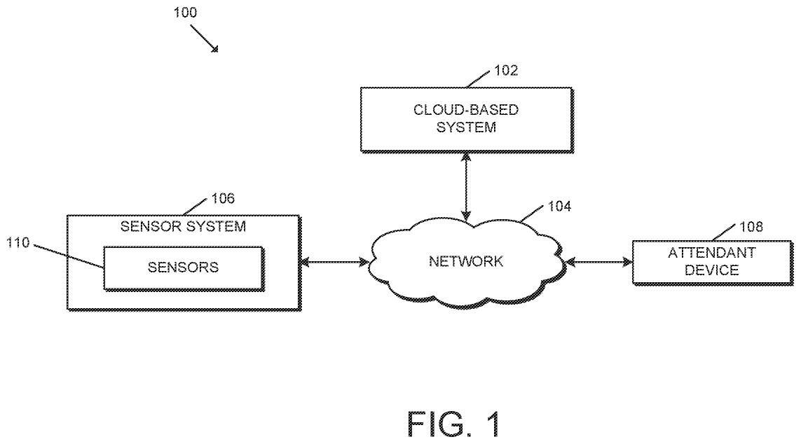

Referring now to FIG. 1, a system 100 for cloud-based analysis and optimization of in-person attendant interactions includes a cloud-based system 102, a network 104, a sensor system 106, and an attendant device 108. Additionally, the illustrative sensor system 106 includes one or more sensors 110. Although only one cloud-based system 102, one network 104, one sensor system 106, and one attendant device 108 are shown in the illustrative embodiment of FIG. 1, the system 100 may include multiple cloud-based systems 102, networks 104, sensor systems 106, and/or attendant devices 108 in other embodiments. For example, in some embodiments, multiple cloud-based systems 102 (e.g., related or unrelated systems) may be used to perform the various functions described herein. Further, in some embodiments, one or more of the systems described herein may be excluded from the system 100, one or more of the systems described as being independent may form a portion of another system, and/or one or more of the systems described as forming a portion of another system may be independent.

The cloud-based system 102 may be embodied as any one or more types of devices/systems capable of performing the functions described herein. For example, in the illustrative embodiment, the cloud-based system 102 may receive and analyze interaction data and/or timestamp data from the sensor system 106 based on one or more interactions that have taken place in a monitored or controlled environment with in-person attendant interactions with clients or other persons (e.g., as in an airport VIP lounge). Although the cloud-based system 102 is described herein in the singular, it should be appreciated that the cloud-based system 102 may be embodied as or include multiple servers/systems in some embodiments. Further, although the cloud-based system 102 is described herein as a cloud-based system, it should be appreciated that the system 102 may be embodied as one or more servers/systems residing outside of a cloud computing environment in other embodiments (e.g., on premises of the sensor system 106). In cloud-based embodiments, the cloud-based system 102 may be embodied as a server-ambiguous computing solution similar to that described below.

The network 104 may be embodied as any one or more types of communication networks that are capable of facilitating communication between the various devices communicatively connected via the network 104. As such, the network 104 may include one or more networks, routers, switches, access points, hubs, computers, and/or other intervening network devices. For example, the network 104 may be embodied as or otherwise include one or more cellular networks, telephone networks, local or wide area networks, publicly available global networks (e.g., the Internet), ad hoc networks, short-range communication links, or a combination thereof. In some embodiments, the network 104 may include a circuit-switched voice or data network, a packet-switched voice or data network, and/or any other network able to carry voice and/or data. In particular, in some embodiments, the network 104 may include Internet Protocol (IP)-based and/or asynchronous transfer mode (ATM)-based networks. In some embodiments, the network 104 may handle voice traffic (e.g., via a Voice over IP (VOIP) network), web traffic (e.g., such as hypertext transfer protocol (HTTP) traffic and hypertext markup language (HTML) traffic), and/or other network traffic depending on the particular embodiment and/or devices of the system 100 in communication with one another. In various embodiments, the network 104 may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. The network 104 may enable connections between the various devices/systems 102, 106, 108, 110 of the system 100. It should be appreciated that the various devices/systems 102, 106, 108, 110 may communicate with one another via different networks 104 depending on the source and/or destination devices/systems 102, 106, 108, 110.

The sensor system 106 includes one or more sensors 110 configured to generate sensor data that may be used by the sensor system 106 and/or the cloud-based system 102 to determine the physical location of one or more clients within the monitored area. The sensors 110 may be embodied as, or otherwise include, pressure sensors, optical sensors, light sensors, electromagnetic sensors, hall effect sensors, audio sensors (e.g., microphones), motion sensors, piezoelectric sensors, cameras, and/or other types of sensors. Of course, the sensor system 106 may also include components and/or devices configured to facilitate the use of the sensors 110. By way of example, the sensors 110 may detect various physical characteristics of the sensor system 106 (internal and/or external to the sensor system 106), electrical characteristics of the sensor system 106, electromagnetic characteristics of the sensor system 106 or its surroundings, and/or other suitable characteristics. Data from the sensors 110 may be used by the sensor system 106 and/or the cloud-based system 102 to determine the physical location of one or more clients within the monitored area, track the amount of time that each of those clients has spent at particular locations, and/or other characteristics related to client movement and/or interactions. It should be appreciated that one or more of the components of the sensor system 106 described herein may be distributed across multiple computing devices in some embodiments. Further, in some embodiments, the sensor system 106 and/or one or more of the sensors 110 may be embodied as IoT devices capable of communicating (e.g., in real time or intermittently) with the cloud-based system 102 via API calls to the cloud-based system 102.

The attendant device 108 may be embodied as any type of device or system of the attendant of the monitored area (e.g., an airport VIP lounge) that may be used by the attendant to interact with clients, check-in clients upon entry at the monitored area, determine client-related information for clients checking in, and/or otherwise capable of performing the functions described herein.

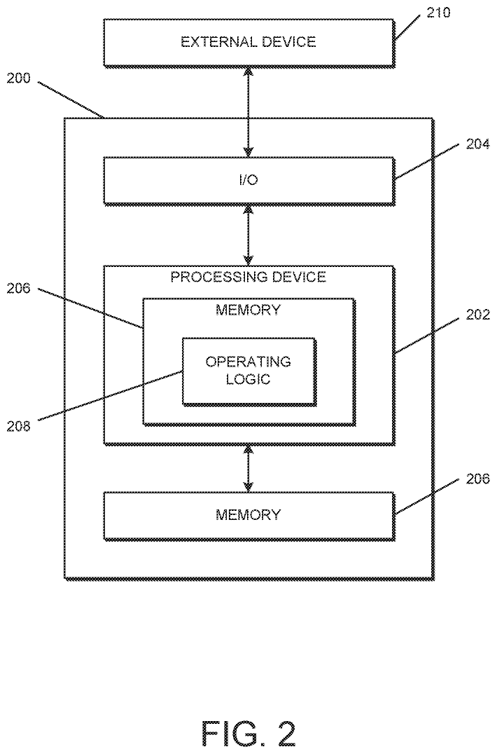

It should be appreciated that each of the cloud-based system 102, the network 104, the sensor system 106, the attendant device 108, and the sensors 110 may be embodied as, executed by, form a portion of, or associated with any type of device/system, collection of devices/systems, and/or portion(s) thereof suitable for performing the functions described herein (e.g., the computing device 200 of FIG. 2). In some embodiments, it should be appreciated that the cloud-based system 102 may be communicatively coupled to a contact center system, form a portion of a contact center system, and/or be otherwise used in conjunction with a contact center system. For example, as described herein, in some embodiments, the cloud-based system 102 may leverage a machine learning model of a contact center system, infrastructure of a contact center system, and/or other aspects of a contact center system to analyze the wait time of clients in a queue, interaction times between clients and attendants, and/or the substance of a conversation between a client and an attendant.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein, the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof depending on the particular embodiment. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

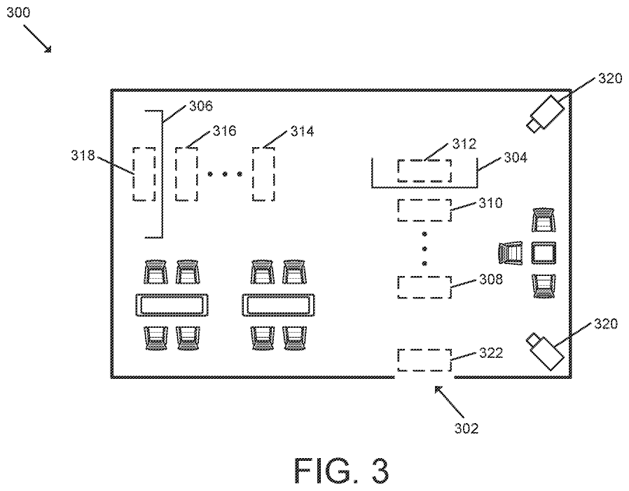

As described in greater detail below, the system 100 may be configured to retrieve sensor data from sensors 110 within a monitored area related to the physical location of a client, the interactions between the client and an attendant, and/or other sensor data, and analyze the sensor data to determine how long the client waited in a queue to check in to the monitored area, how long the client waited in a queue to obtain/access a good or service within the monitored area, and/or how long a client interaction with an attendance took. Further, the substance of such interactions may also be recorded by the sensors 110. Accordingly, referring now to FIG. 3, a simplified floor plan of an exemplary monitored area 300 (e.g., of an airport VIP lounge) that may leverage the technologies described herein is shown. The illustrative monitored area 300 includes a door 302 through which clients gain access to the area 300, a front desk 304 at which clients are to check-in with an attendant, and a refreshment center 306 at which clients may obtain one or more refreshments.

As shown, the illustrative monitored area 300 includes multiple sensors 110 for detecting the presence of a client within the monitored area 300. For example, the illustrative embodiment of the monitored area 300 includes a first set of sensors 110 (i.e., the sensors 308, 310) associated with a queue to the front desk 304, and a second set of sensors 110 (i.e., the sensors 314, 316) associated with a queue to the refreshment center 306. Additionally, the sensor 312 is associated with an attendant location at the front desk 304, and the sensor 318 is associated with an attendant location at the refreshment center 306. Although the illustrative embodiment only depicts two sensors 110 associated with each of the queues (i.e., at a start position and end position), it should be appreciated that the queue may be associated with additional sensors 110 intermediate the respective start position and end position in other embodiments. In the illustrative embodiment, each of the sensors 308, 310, 312, 314, 316, 318 is embodied as a pressure sensor configured to detect when a client has stepped on the corresponding sensor 308, 310, 312, 314, 316, 318. However, it should be appreciated that one or more of the sensors 308, 310, 312, 314, 316, 318 may be embodied as another type of sensor 110 in other embodiments.

More specifically, after entering the monitored area 300 through the door 302, the client may approach the front desk 304 to check into the monitored area 300 (e.g., by showing the attendant the client's access credentials, such as a membership card or a plane ticket in an airport VIP lounge). As the client approaches the front desk 304, the client may enter a queue at a queue start position at which the sensor 308 is located. The client progresses through the queue, and the client eventually reaches a queue end position at which the sensor 310 is located. The sensor 312 may be used to confirm that an attendant is located at the front desk 304 and, if so, begin recording the interaction between the client and the attendant at the front desk 304. Similarly, after checking in to the monitored area 300 at the front desk 304, the client may go to the refreshment center 306 for a snack or beverage. As the client approaches the refreshment center 306, the client may enter a queue at a queue start position at which the sensor 314 is located. The client progresses through the queue, and the client eventually reaches a queue end position at which the sensor 316 is located. The sensor 318 may be used to confirm that an attendant is located at the refreshment center 306 and, if so, begin regarding the interaction between the client and the attendant at the refreshment center 306.

Additionally or alternatively, the monitored area 300 may include one or more sensors 320 configured to track the client in a more refined manner. In the illustrative embodiment, each of the sensors 320 is embodied as a camera, which may capture images of the clients as they enter the monitored area 300 through the door 302 and track the clients throughout the monitored area. Further, in some embodiments, the monitored area 300 may include a sensor 322 (e.g., a pressure sensor) configured to detect when a client enters the monitored area 300 through the door 302.

It should be further appreciated that, in some embodiments, the location of the attendants may be monitored, for example, to determine the start of the attendant's shift, the end of the attendant's shift, shift breaks taken by the attendant, and/or other characteristics that may be relevant in determining the location or presence of the attendant in the monitored area 300. For example, in some embodiments, the monitored area 300 may include an attendant entrance (e.g., the door 302 and/or a separate entrance) through which the entry and exit of attendants may be monitored. In some embodiments, the attendants' entry and/or exit through the attendant entrance may be determined by using a punch card, mobile application, sensor 110 such as a credential reader (e.g., card swipe), communication circuitry (e.g., to communicate with the attendant device 108, mobile phone of the attendant, and/or another device), and/or other mechanism. Accordingly, the actual presence or absence of an attendant within the monitored area 300 may be tracked along with corresponding times. In other words, the actual number of attendants present may be known rather than simply the number of attendants scheduled to be present in the monitored area 300 at that time.

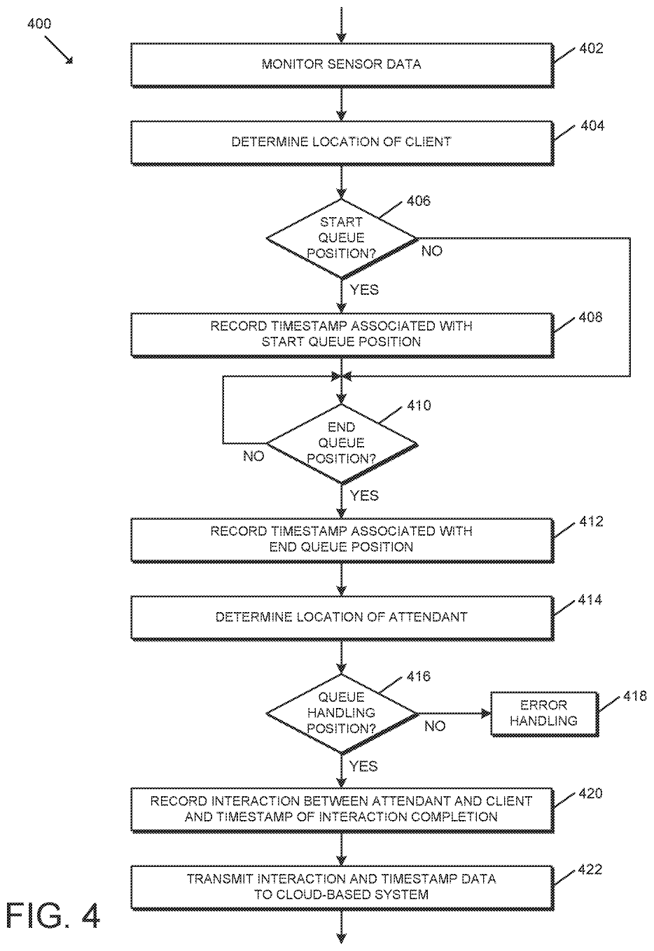

Referring now to FIG. 4, in use, the system 100 may execute a method 400 for recording data for the cloud-based analysis and optimization of in-person attendant interactions. It should be appreciated that the particular blocks of the method 400 are illustrated by way of example, and such blocks may be combined or divided, added or removed, and/or reordered in whole or in part depending on the particular embodiment, unless stated to the contrary. For simplicity and brevity of the description, the various blocks of the method 400 are primarily described below as being performed by the sensor system 106. However, it should be appreciated that the various blocks of the method 400 may be performed by the sensor system 106, the individual sensors 110, the attendant device 108, and/or another device of the system 100 depending on the particular embodiment.

The illustrative method 400 begins with block 402 in which the sensor system 106 monitors sensor data generated by the sensors 110 of the sensor system 106 and, in block 404, the sensor system 106 determines the physical location of a client in a monitored area based on the sensor data. For example, in some embodiments, the sensor system 106 may include a plurality of sensors 110 with each of those sensors 110 corresponding which a particular physical location in the monitored area, such that if the client is detected by a particular sensor 110, the sensor system 106 may ascertain the location of the client. In particular, as described above, in some embodiments, the sensor system 106 may utilize a plurality of pressure sensors such that the client's position is detected and known when the client steps on one of the pressure sensors. Further, as described above in reference to the example monitored area 300 of FIG. 3, the monitored area 300 may include a queue to interact with an attendant that has a predefined start position and a predefined end position, each position being detectable by the sensor system 106 (e.g., by corresponding pressure sensors positioned at those positions).

In block 406, the sensor system 106 determines whether the client is located at the start queue position based on the sensor data (e.g., based on sensor data generated by a pressure sensor positioned at the start queue position). If not, the method 400 advances to block 410. However, if the client is located at the start queue position, in block 408, the sensor system 106 records a timestamp associated with a time at which the client arrived at the start queue position. For example, the sensor system 106 may store data indicating that a particular client arrived at the start queue position at a particular start queue time. In block 410, the sensor system 106 determines whether the client is located at the end queue position based on the sensor data (e.g., based on sensor data generated by a pressure sensor positioned at the end queue position). If so, in block 412, the sensor system 106 records a timestamp associated with a time at which the client arrived at the end queue position. For example, the sensor system 106 may store data indicating that a particular client arrived at the end queue position at a particular end queue time.

In block 414, the sensor system 106 determines the location of the attendant based on the sensor data. More specifically, the sensor system 106 may determine whether the attendant is located at a queue handling position at which the attendant should be located to interact with clients in the queue based on the sensor data (e.g., based on sensor data generated by a pressure sensor positioned at the queue handling position). For example, in some embodiments, the queue handling position may be behind a front desk at which the attendant receives clients who are standing in the queue. If the sensor system 106 determines, in block 416, that the attendant is not located in the queue handling position, the method 400 advances to block 418 in which the sensor system 106 employs one or more error handling measures. For example, in some embodiments, the attendant or manager on duty may be alerted to the presence of a client at the start queue position and, therefore, the need for an attendant to be available to assist the client.

If the sensor system 106 determines that the attendant is located at the queue handling position, the method 400 advances to block 420 in which the sensor system 106 records interaction data of the interaction between the client and the attendant, along with one or more timestamps indicating when the interaction started and/or ended. In some embodiments, it should be appreciated that the interaction data may include a full audio and/or video recording of the interaction between the client and the attendant, which may be translated to text using speech recognition technologies. In block 422, the sensor system 106 transmits the interaction data, along with the timestamp data, to the cloud-based system 102 for further analysis. As described above, in some embodiments, the sensor data may be transmitted from the sensors 110 directly to the cloud-based system 102 (e.g., via appropriate API calls), whereas in other embodiments, the sensor data may be transmitted to the cloud-based system 102 by the sensor system 106, attendant device 108, and/or other device of the system 100.

Although the blocks 402-422 are described in a relatively serial manner, it should be appreciated that various blocks of the method 400 may be performed in parallel in some embodiments. It should be appreciated that the method 400 of FIG. 4 may be executed for each client-attendant interaction in the monitored area.

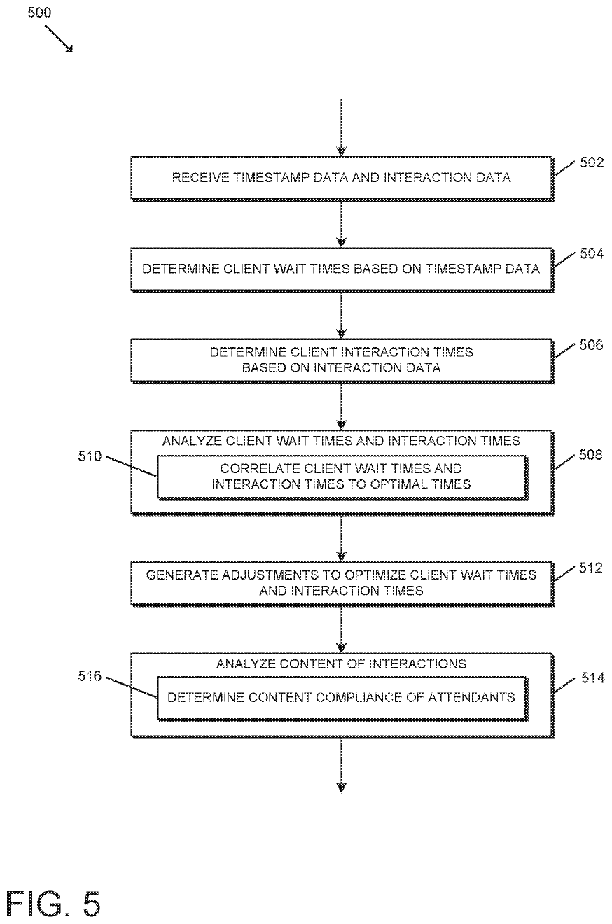

Referring now to FIG. 5, in use, the system 100 may execute a method 500 for analyzing and optimizing in-person attendant interactions. It should be appreciated that the particular blocks of the method 500 are illustrated by way of example, and such blocks may be combined or divided, added or removed, and/or reordered in whole or in part depending on the particular embodiment, unless stated to the contrary. It should be further appreciated that, in some embodiments, the method 500 of FIG. 5 may be executed in conjunction with the method 400 of FIG. 4. For simplicity and brevity of the description, the various blocks of the method 500 are primarily described below as being performed by the cloud-based system 102. However, it should be appreciated that the various blocks of the method 500 may be performed by the sensor system 106, the attendant device 108, and/or another devices of the system 100 depending on the particular embodiment. Further, one or more of the analyses described below may be performed outside of a cloud computing environment.

The illustrative method 500 begins with block 502 in which the cloud-based system 102 received interaction data, along with timestamp data, from the sensor system 106 (see, for example, block 422 of the method 400 of FIG. 4). Although referenced in the singular with respect to the method 400 of FIG. 4, it should be appreciated that the cloud-based system 102 may receive and analyze interaction data related to numerous client-attendant interactions.

In block 504, the cloud-based system 102 determines (e.g., for each of the client-attendant interactions) a wait time of the client in the respective queue based on the start queue time and the end queue time received for that particular interaction. For example, the cloud-based system 102 may infer that the client's wait time was the difference between the end queue time and the start queue time as reflected in the corresponding timestamp data. In block 506, the cloud-based system 102 determines (e.g., for each of the client-attendant interactions) an interaction time of the client with the attendant based on the interaction data associated with that particular interaction. For example, in some embodiments, the recorded interaction may include both a start time and end time for the interaction, which may be used to determine the duration of the interaction. In other embodiments, the interaction data may only include a timestamp for the completion of the interaction in which case the cloud-based system 102 may infer that the interaction time/duration was the difference between the interaction end time and the end queue time (i.e., the time at which the client arrived at the start of the queue to speak with the attendant).

In block 508, the cloud-based system 102 analyzes the client wait times and interaction times in an effort to optimize in-person attendant interactions. In doing so, in block 510, the cloud-based system 102 may correlated client wait times and interactions times to optimal times associated with a positive client experience. For example, the cloud-based system 102 may have a predefined optimum amount of time that a client should spend in a queue, including acceptable thresholds for minimum queue duration and maximum queue duration, against which the client wait times may be measured. Similarly, the cloud-based system 102 may have a predefined optimum amount of time that an attendant should spend interaction with a particular client, including acceptable thresholds for minimum interaction duration and maximum interaction duration. For example, in an embodiment, the system 100 may determine that the optimum amount of time for a client to spend in a queue is 30 seconds with an acceptable range of 15 seconds to 60 seconds, and the optimum amount of time for an attendant to spend interacting with a client is 3 minutes with acceptable range of 2 minutes to 5 minutes. If the client wait times and/or interaction times are outside of the defined ranges, the cloud-based system 102 may determine that adjustments are needed to the attendant schedule (e.g., increasing/decreasing staffing at certain parts of the day, such as increasing/decreasing the number of attendants scheduled for a certain shift) and/or further attendant training is justified in order to improve the wait times and/or interaction times. In some embodiments, the cloud-based system 102 may generate alerts to the attendant, secondary attendant, and/or supervisors to intervene if the wait times and/or interaction times are outside of the acceptable ranges (e.g., in real time or subsequently). As such, in block 512, the cloud-based system 102 may generate one or more adjustments to the attendant schedule or otherwise to optimize client wait times and/or interaction times. For example, the objective may be to increase the number of queues and interactions that fall near the optimal time/duration.

In block 514, the cloud-based system 102 may also analyze the content of the interactions between the attendants and the clients (e.g., for each of the attendants), for example, using speech recognition technologies, artificial intelligence, machine learning, and/or other analytical technologies. In doing so, in block 516, the cloud-based system 102 may determine whether the interactions satisfy one or more content compliance requirements. For example, in an airline VIP lounge embodiment, the cloud-based system 102 may determine whether the attendant welcomed the client, asked the client for his or her ticket, confirmed that the client has access to the VIP lounge, directed the client to the refreshment center, and said “Goodbye.” It should be appreciated that the compliance requirements may vary depending on the particular embodiment and may vary over time, as the cloud-based system 102 further refines what provides for an optimal client experience. As described above, in some embodiments, the cloud-based system 102 may be leverage machine learning models, infrastructure, algorithms, and/or other technologies related to contact center systems in analyzing the data described herein.

Although the blocks 502-516 are described in a relatively serial manner, it should be appreciated that various blocks of the method 500 may be performed in parallel in some embodiments.

What is claimed is:

1. A method for analysis of in-person attendant interactions, the method comprising:
determining a physical location of a person within a monitored area based on sensor data generated by one or more sensors;
determining a start queue time associated with a time at which the person is located at a start queue position of a queue within the monitored area in response to determining that the person is located at the start queue position;
determining an end queue time associated with a time at which the person is located at an end queue position of the queue within the monitored area in response to determining that the person is located at the end queue position;
recording interaction data of an interaction between the person and an attendant when the person is located at the end queue position;
determining a wait time of the person in the queue based on the start queue time and the end queue time;
determining an interaction time of the interaction between the person and the attendant based on the interaction data; and
adjusting an attendant schedule of one or more attendants of the monitored area to improve one or more of the wait time and the interaction time.

2. The method of claim 1, wherein the one or more sensors comprise a plurality of pressure sensors.

3. The method of claim 1, wherein the one or more sensors comprise a first sensor and a second sensor;
wherein determining the start queue time comprises determining the start queue time in response to determining that sensor data generated by the first sensor is indicative of the person being located at the start queue position; and
wherein determining the end queue time comprises determining the end queue time in response to determining that sensor data generated by the second sensor is indicative of the person being located at the end queue position.

4. The method of claim 3, wherein the first sensor comprises a first pressure sensor; and
wherein the second sensor comprises a second pressure sensor.

5. The method of claim 1, wherein the one or more sensors comprise a camera.

6. The method of claim 1, further comprising determining a physical location of the attendant based on the sensor data generated by the one or more sensors; and
wherein recording the interaction data of the interaction between the person and the attendant comprises recording the interaction data when the person is located at the end queue position and the attendant is located at a queue handling position.

7. The method of claim 1, further comprising:
analyzing a plurality of wait times including the wait time of the person in the queue based on an optimal wait time; and
analyzing a plurality of interaction times including the interaction time of the interaction between the person and the attendant based on an optimal interaction time.

8. The method of claim 1, further comprising analyzing, using speech recognition, content of the interaction between the person and the attendant based on the interaction data to determine content compliance of the attendant.

9. The method of claim 1, further comprising transmitting the sensor data to a cloud-based computing system via an Application Programming Interface (API);
wherein determining the wait time of the person comprises determining the wait time of the person by the cloud-based computing system; and
wherein determining the interaction time of the interaction comprises determining the interaction time of the interaction by the cloud-based computing system.

10. The method of claim 1, further comprising analyzing the wait time of the person in the queue and the interaction time of the interaction based on a machine learning model of a contact center system.

11. A system for analysis of in-person attendant interactions, the system comprising:
one or more sensors configured to generate sensor data;
at least one processor; and
at least one memory comprising a plurality of instructions stored thereon that, in response to execution by the at least one processor, causes the system to:
determine a physical location of a person within a monitored area based on the sensor data generated by the one or more sensors;
determine a start queue time associated with a time at which the person is located at a start queue position of a queue within the monitored area in response to a determination that the person is located at the start queue position;
determine an end queue time associated with a time at which the person is located at an end queue position of the queue within the monitored area in response to a determination that the person is located at the end queue position;
record interaction data of an interaction between the person and an attendant when the person is located at the end queue position;
determine a wait time of the person in the queue based on the start queue time and the end queue time;
determine an interaction time of the interaction between the person and the attendant based on the interaction data; and
adjust an attendant schedule of one or more attendants of the monitored area to improve one or more of the wait time and the interaction time.

12. The system of claim 11, wherein to adjust the attendant schedule of the one or more attendants of the monitored area comprises to increase a number of attendants scheduled for a predefined shift.

13. The system of claim 11, wherein the one or more sensors comprise a first sensor and a second sensor;
wherein to determine the start queue time comprises to determine the start queue time in response to a determination that sensor data generated by the first sensor is indicative of the person being located at the start queue position; and
wherein to determine the end queue time comprises to determine the end queue time in response to a determination that sensor data generated by the second sensor is indicative of the person being located at the end queue position.

14. The system of claim 13, wherein the first sensor comprises a first pressure sensor; and
wherein the second sensor comprises a second pressure sensor.

15. The system of claim 11, wherein the one or more sensors comprise a camera.

16. The system of claim 11, wherein the plurality of instructions further causes the system to determine a physical location of the attendant based on the sensor data generated by the one or more sensors; and
wherein to record the interaction data of the interaction between the person and the attendant comprises to record the interaction data when the person is located at the end queue position and the attendant is located at a queue handling position.

17. The system of claim 11, wherein the plurality of instructions further causes the system to:
analyze a plurality of wait times including the wait time of the person in the queue based on an optimal wait time; and
analyze a plurality of interaction times including the interaction time of the interaction between the person and the attendant based on an optimal interaction time.

18. The system of claim 11, wherein the plurality of instructions further causes the system to analyze, using speech recognition, content of the interaction between the person and the attendant based on the interaction data to determine content compliance of the attendant.

19. The system of claim 11, wherein the plurality of instructions further causes the system to transmit the sensor data to a cloud-based computing system via an Application Programming Interface (API);
wherein to determine the wait time of the person comprises to determine the wait time of the person by the cloud-based computing system; and
wherein to determine the interaction time of the interaction comprises to determine the interaction time of the interaction by the cloud-based computing system.

20. The system of claim 11, wherein the plurality of instructions further causes the system to analyze the wait time of the person in the queue and the interaction time of the interaction based on a machine learning model of a contact center system.
